(19) United States
(12) Patent Application Publication
(10) Pub. No.: US 2004/0029016 A1
(43) Pub. Date: Feb. 12, 2004

(54) Polymer electrolyte for lithium-sulfur battery and lithium-sulfur battery comprising same

(76) Inventors: Duck-Chul Hwang, Suwon-city (KR); Kyoung-Hee Lee, Cheonan-city (KR)

Correspondence Address: CHRISTIE, PARKER & HALE, LLP, P.O. BOX 7068, PASADENA, CA, 91109-7068, US

(21) Appl. No.: 10/635,122

(22) Filed: Aug. 6, 2003

(30) Foreign Application Priority Data
Aug. 7, 2002 (KR) 2002-0046580
May 7, 2003 (KR) 2003-0028968

(51) Int. Cl. H01M 10/40

(52) U.S. Cl. 429/317; 429/189; 429/307

(57) ABSTRACT

Disclosed is a polymer electrolyte for a lithium sulfur battery. The electrolyte includes a monomer with a methacrylate group, an initiator, an organic solvent, and a lithium salt.

### CROSS REFERENCE TO RELATED APPLICATION

This application claims priority of Korean Patent Application Nos. 2002-46580 and 2003-28968 filed in the Korean Intellectual Property Office on Aug. 7, 2002, and May 7, 2003, respectively, the disclosures of which are incorporated hereinto by reference.

1. Field of the Invention

The present invention relates to a polymer electrolyte for a lithium sulfur battery and a lithium-sulfur battery comprising the same, and more particularly, to a polymer electrolyte for a lithium sulfur battery that can provide batteries exhibiting good cycle life characteristics, and a lithium-sulfur battery comprising the same.

### BACKGROUND OF THE INVENTION

The development of portable electronic devices has led to a corresponding increase in the demand for secondary batteries that both weigh less and have a higher capacity. To satisfy these demands, the most promising approach is a lithium-sulfur battery with a positive electrode made of sulfur-based compounds.

Lithium-sulfur batteries use sulfur-based compounds with sulfur-sulfur bonds as a positive active material, and a lithium metal or a carbon-based compound as a negative active material. The carbon-based compound is one that can reversibly intercalate or deintercalate metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are re-formed, resulting in an increase in the oxidation number of the S. The electrical energy is stored in the battery as chemical energy during charging and is converted back to electrical energy during discharging.

With respect to specific density, the lithium-sulfur battery is the most attractive among the currently developing batteries since lithium has a specific capacity of 3,830 mAh/g, and sulfur has a specific capacity of 1,675 mAh/g. Further, the sulfur-based compounds are less costly than other materials, and they are environmentally friendly.

However, employing a positive electrode based on elemental sulfur in an alkali metal-sulfur battery system has been considered problematic. Although theoretically the reduction of sulfur to an alkali metal-sulfide confers a large specific energy, sulfur is known to be an excellent insulator, and problems using it for an electrode have been noted. Such problems include a very low percentage of utilization and a low cycle life characteristic as a result of the sulfur and lithium sulfide (Li₂S) dissolved and diffused from the positive electrode.

Furthermore, the high reactivity of lithium metal negative active materials makes them undesirably react with electrolytes. The reaction generates dendrites of lithium metal, thereby deteriorating cycle life characteristics.

Thus, there have been various attempts to reduce the reactivity between the lithium metal and the electrolyte.

### SUMMARY OF THE INVENTION

In one embodiment, the invention is directed to a polymer electrolyte for a lithium sulfur battery including a monomer; an intiator; an organic solvent; and a lithium salt. The monomer includes methacrylate groups.

The present invention also provides a lithium sulfur battery including the polymer electrolyte, a positive electrode, and a negative electrode. The positive electrode includes at least one positive active material selected from elemental sulfur, sulfur-based compounds, and mixtures thereof. The negative electrode includes a negative active material selected from materials that are capable of reversibly intercalating or deintercalating lithium ions, materials that react with lithium ions to prepare a lithium-included compound, lithium metals, and lithium alloys.

The inventive polymer electrolyte has been advantageously found to effectively protect lithium metal and, when used in a lithium sulfur battery, causes the battery to exhibit good cycle life characteristics.

### BRIEF DESCRIPTION OF THE DRAWINGS

The patent or application file contains at least one photograph in color. Copies of this patent or patent application publication with color photographs will be provided by the Office upon request and payment of the necessary fee. A more complete appreciation of the invention, and many of the attendant advantages thereof, will be readily apparent as the same becomes better understood by reference to the following detailed description when considered in conjunction with the accompanying drawings, wherein:

FIG. 1 is a photograph showing a negative electrode according to Example 1 of the present invention, after a cycle life test of the lithium sulfur cell was done;

FIG. 2 is a photograph showing a negative electrode according to Comparative Example 1, after a cycle life test of the lithium sulfur cell was done;

FIG. 3 is a graph illustrating cycle life characteristics of the lithium sulfur cells according to Example 1 of the present invention and Comparative Example 1; and

FIG. 4 is a perspective view of a battery according to the invention.

### DETAILED DESCRIPTION OF THE INVENTION

Generally, a liquid-type electrolyte (hereinafter referred to as “electrolytic solution”) is used in a lithium sulfur battery, which results in the occurrence of a reaction between a negative active material, especially lithium metal, and the electrolytic solution.

In order to prevent the reaction, the present invention provides a new polymer electrolyte in the lithium sulfur batteries rather than the electrolytic solution. Conventionally, polymer electrolytes are only applied to lithium ion batteries and cannot be applied to lithium sulfur batteries. A general polymer electrolyte is disclosed in U.S. Pat. No. 6,329,103, in which a polymer electrolyte with a polymerizable alkylene oxide polymer is taught, and in U.S. Pat. No. 5,925,283, in which a halogen-substituted carbonic ester (non-cyclic carbonic-ester) gel polymer is taught.

The present invention is directed to a polymer electrolyte that does not react with lithium metal. Thus, the polymer electrolyte does not cause deterioration of the cycle life characteristic associated with lithium dendrites by the reaction between a conventional electrolytic solution and lithium metal. Such a polymer electrolyte may be a gel polymer electrolyte, or alternatively a gelled solution-included polymer electrolyte. The gelled solution-included polymer electrolyte is polymerized to form a gel at about 75° C. in the battery.

The polymer electrolyte includes a methacrylate-included monomer and an initiator. In addition, the polymer electrolyte includes an organic solvent and a lithium salt. In the application, the organic solvent and a lithium salt are referred to as “electrolytic solution”.

The monomer has at least one carbon-carbon double bond at a terminal end. Examples include multifunctional acrylates, poly(ethyleneglycol) dimethacrylate, poly(ethyleneglycol) diacrylate, poly(ethyleneglycol) divinylether ethylene glycol dimethacrylate, ethyleneglycol diacrylate, ethyleneglycol divinyl ether hexanediol diacrylate, tripropyleneglycol diacrylate, tetraethyleneglycol monoacrylate, caprolactone acrylate, and mixtures thereof Preferred are multifunctional acrylates and poly(ethyleneglycol) dimethacrylate, and most preferred is a multifunctional acrylate. The term “multifunctional acrylate” indicates poly(ester)(metha)(acrylate) in which hydroxide groups in (polyester)polyol with at least three hydroxides (—OH) are partially or totally substituted with (metha)acrylic ester, and un-substituted hydroxide groups are substituted with groups having no radical reactivity. Examples of suitable multifunctional acrylates are monomers represented by formulas 1 and 2:

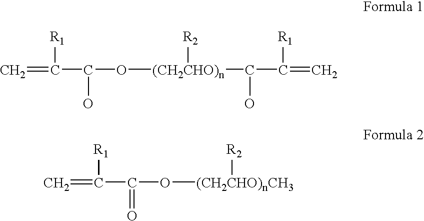

where R₁ is H or a C₁ to C₆ alkyl group;

n is an integer ranging from 1 to 100,000; and

R₂ is H or a C₁ to C₆ alkyl group.

The mixing weight ratio of the electrolytic solution and the monomer is preferably more than 10 and 200 or less:1, more preferably 40 to 150:1, and most preferably 60 to 120:1.

An amount of 10 times or less of the electrolytic solution to the monomer causes activation of a subsequent polymerization and forms a rigid solid electrolyte. The polymer electrolytes used in lithium sulfur batteries preferably have substantially intermediate physical properties between liquid and solid and more preferably properties closer to liquid rather than solid. An amount of more than 200 times the amount of electrolytic solution causes it to be squeezed from a polymer matrix.

The electrolyte includes an electrolytic salt and an organic solvent. The organic solvent may be a sole solvent or a mixed organic solvent with at least two components. The mixed organic solvent includes at least two groups selected from weak polar solvent groups, strong polar solvent groups, and lithium protection groups. Some electrolytes include at least one or more solvents selected from the same group.

The term “weak polar solvent”, as used herein, is defined as a solvent that is capable of dissolving elemental sulfur and that has a dielectric coefficient of less than 15. The weak polar solvent may be selected from aryl compounds, bicyclic ether, and acyclic carbonate compounds. The term “strong polar solvent”, as used herein, is defined as a solvent that is capable of dissolving lithium polysulfide and that has a dielectric coefficient of more than 15. The strong polar solvent may be selected from bicyclic carbonate compounds, sulfoxide compounds, lactone compounds, ketone compounds, ester compounds, sulfate compounds and sulfite compounds. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. The lithium protection solvent may be selected from saturated ether compounds, unsaturated ether compounds, and heterocyclic compounds including N, O, and/or S.

Examples of the weak polar solvents include xylene, dimethoxyethane, 2-methyltetrahydrofurane, diethyl carbonate, dimethyl carbonate, toluene, dimethyl ether, diethyl ether, diglym, and tetraglyme.

Examples of the strong polar solvents include hexamethyl phosphoric triamide, Υ-butyrolactone, acetonitrile, ethylene carbonate, propylene carbonate, N-methyl pyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, and ethylene glycol sulfite.

Examples of the lithium protection solvents include tetrahydrofuran, 1,3-dioxolane, 3,5-dimethylisoxazole, 2,5-dimethyl furane, furane, 2-methyl furane, 1,4-oxane, and 4-methyldioxolane.

Examples of electrolyte salts which are optional for the battery of this invention include lithium trifluoromethane sulfonimide, lithium triflate, lithium perchlorate, LiPF₆, LiBF₄, tetraalkylammonium salts such as tetrabutylammonium tetrafluoroborate (TBABF₄), liquid state salts at room temperature such as an imidazolium salt, such as 1-ethyl-3-methylimidazolium Bis-(perfluoroethyl sulfonyl) imide (EMIBeti), and mixtures thereof. The concentration of the lithium salt is preferably 0.6 to 2.0M, and more preferably 0.7 to 1.6M. If the concentration of the lithium salt is less than 0.6M, the conductivity of the electrolyte decreases, thereby deteriorating battery performance. If the concentration of the lithium salt is more than 2.0M, the viscosity of the electrolyte increases, thereby deteriorating movement of lithium ions.

All acrylate groups in the poly(ester)(metha)acrylate monomer of the present invention participate in the polymerization. Thus, the poly(ester)(metha)acrylate monomer of the present invention has no shortcomings such as inferior low-temperature and cycle life characteristics, such as are associated with a non participation acrylate group.

The polyester polyol with at least three hydroxide groups may be obtained from general preparations, e.g. condensation polymerization of hydroxyl carbonic acid, open polymerization of lactone, or condensation polymerization of glycol and dicarbonic acid, or alternatively from markets. Examples of the polyester polyol include trialkylols such as trimethylol, triethylol, and tripropylol; glycerols; and erythritols such as pentaerythritol and dipentaerythritol.

The hydroxide groups in the polyester polyol are partially or totally substituted with (metha)acrylic ester, and un-substituted hydroxide groups are substituted with a group having no radical reactivity, thereby producing poly(ester)(metha)acrylate or polymers thereof.

The substitution procedure may be performed under a condition of general esterification: a condensation of polyesterpolyol and (metha)acrylic halide in the presence of basic catalysts, or a condensation of polyesterpolyol and (metha)acrylic acid in the presence of acidic catalysts.

The condensation in the presence of basic catalysts will be illustrated below.

The (metha)acrylic acid halide may be acrylic chloride or (metha)acrylic chloride. The amount of the (metha)acrylic acid halide is suitably 0.5 to 5 equivalents based on 1 M of a hydroxide group in polyesterpolyol.

The basic catalyst may be an organic base such as triethylamine, pyridine, dimethylaminopyridine, or iazabicycloundecene, or an inorganic base such as lithium carbonate, sodium carbonate, potassium carbonate, lithium hydroxide, sodium hydroxide, or potassium hydroxide. The amount of the basic catalyst is preferably 1.0 to 5.0 equivalents based on the amount of (metha)acrylic halide.

The reaction may be performed in the presence or absence of a solvent. Useful solvents include halogenated hydrocarbons such as dichloroethane and chloroform; aromatic hydrocarbons such as benzene, toluene, and xylene; saturated hydrocarbons such as hexane, heptane, decane and cyclohexane; and ethers such as diethylether, diisopropylether, and tetrahydrofurane.

The reaction may be performed at −20 to 100° C., and preferably −5 to 50° C.

The condensation in the presence of acidic catalysts will be illustrated in more detail.

The amount of (metha)acrylic acid is preferably 0.1 to 10M based on 1M of a hydroxide group in polyesterpolyol. The acidic catalyst may be sulfuric acid, methane sulfonic acid, p-toluene sulfonic acid, hydrochloric acid, phosphoric acid, tungsten phosphate, or molybdenum phosphate. The amount of the acidic catalyst is preferably 0.01 to 10 wt % to polyesterpolyol.

The reaction is performed in an inert solvent, such as an aromatic hydrocarbon, e.g., benzene, toluene, or xylene; or a saturated hydrocarbon, e.g., hexane, heptane, decane or cyclohexane. The produced water is preferably removed by an azeotropic reaction. The amount of the solvent is 0.1 to 10 parts by weight to polyesterpolyol. The reaction is performed at 50 to 200° C., and preferably 70 to 150° C.

According to the aforementioned procedure, hydroxide groups in the polyol are partially or totally substituted with (metha)acrylic ester. The substituted (metha)acrylic ester is preferably —OC(═O)(CH₂)ₙOC(═O)CH═CH₂ or —OC(CH₂)ₙC(CH₃)═CH₂, where n is an integer from 1 to 20.

Un-substituted hydroxide groups are substituted with groups having no radical reactivity (hereinafter, “radical unreactivity group).

The radical unreactivity group may be selected from C₁ to C₂₀ aliphatic hydrocarbons, C₆ to C₂₀ aromatic hydrocarbons, C₁ to C₂₀ ethers, and preferably OC(═O)(CH₂)₂CH₃,—O(C═O)Ar where Ar is an unsubstituted or substituted aromatic hydrocarbon, OC(═O)(CH₂)ₙO(CH₂)ₙ(CH₃), where n is an integer from 1 to 20, —O(C═O)(CH₂)ₙOC(═O)(CH₂)ₙCH₃, where n is an integer from 1 to 20, and —O(C═O)CH═CH₂.

One of the procedures includes esterification of unreacted hydroxide groups using the radical unreactivity groups corresponding to the hydroxide groups. The radical unreactivity groups may be carbonyl acid or a halogen compound having a C₁ to C₂₀ aliphatic hydrocarbon; or a carbonyl-based or halogen compound having a C₆ to C₂₀ aromatic hydrocarbon, a C₁ to C₂₀ ether, or a C₁ to C₂₀ ester. An example thereof is butyl carbonic acid.

A modified polyester polyol may be used in the esterification. The modified polyester polyol is obtained from the ring-open polymerization of polyester polyol with lactones, and it has a modified structure. The modified polyester polyol renders control of a length of hydroxide groups which act as reactive groups in the molecular structure so that it effectively controls the physical properties of the electrolyte. The lactone may be ε-caprolactone or γ-caprolactone. The amount of the lactones depends on the total hydroxide groups of the polyesterpolyol. Thus, it is not necessary to limit the amount of the lactones, but according to solubility and size of molecules of the lactone-substituted modified polyester polyol, the amount of the lactones is 1000 mole % or less of the total hydroxide groups of the polyesterpolyol, and preferably 0.01 to 10M:1M of the hydroxide groups of the polyol.

The catalyst to activate the ring-open polymerization may be selected from organic titanium-based compounds, organic tin-based compounds, and metal salts of an organic carbonic acid. An example of the organic titanium-based compound is tetrapropyltitanate.

The amount of the catalyst is preferably 0.001 to 1 parts by weight per 100 parts by weight of the lactones.

If a modified polyesterpolyol is used, the modified polyesterpolyol, acrylic acid or derivatives thereof, and the compound having a radical unreactivity group, are simultaneously mixed to cause esterification. The mole ratios between the three materials allows the determination of a ratio between a substitution with (metha)acrylic ester and a substitution with a radical unreactivity group.

According to the aforementioned procedure, poly(ester)(metha)acrylate or a polymer thereof is prepared.

A preferred monomer is represented by Formula 3.

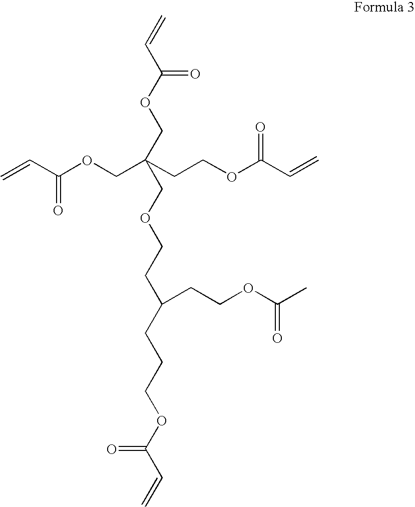

The mole ratio of (metha)acrylic ester and the radical unreactivity group is preferably 1:0.01 to 1:100. If the mole ratio is less than 1:0.01, the degree of crosslinkage increases to decrease ionic conductivity. If the mole ratio is more than 1:100, it does not activate a crosslink so it forms no polymer.

The polymer electrolyte includes an initiator. The initiator acts to initiate polymerization of a polyester (metha)acrylate polymer, and has a —C(═O)—O—O—C(═O)-polar (hydrophilic) portion and a C₆ to C₄₀ aliphatic or aromatic hydrocarbon nonpolar (hydrophobic) portion.

The initiator generates CO₂ with good affinity with an electrolyte to improve initial charge and discharge efficiency of the battery, compared with an azobenzen-based initiator such as 2,2′-azoisobutyronitrile, which generates an inert gas, N₂, with no solubility to the electrolyte.

The initial charge and discharge efficiency of the lithium sulfur battery depends on a thin layer on the electrode, especially on the negative electrode. The morphology of the thin layer affects the battery performance. Evenness of the thin layer renders good initial charge and discharge efficiency, and unevenness (extraction of lithium) causes inferior initial charge and discharge efficiency.

Examples of the initiators include isobutyl peroxide, lauroyl peroxide, benzoyl peroxide, m-toluoyl peroxide, t-butyl peroxy-2-ethyl hexanoate, t-butyl peroxybibarate, t-butyloxyneodecanate, deisopropyl peroxy dicarbonate, diethoxy peroxy dicarbonate, bis-(4-t-butylcyclohexyl)peroxy dicarbonate, dimethoxy isopropyl peroxy dicarbonate, dicyclohexylperoxy dicarbonate, 3,3,5-trimethylhexanoyl peroxide, succinic peroxide didecarbonylperoxide, dicumyl peroxide, di-t-butyl peroxide, 2,5-dimethyl-2,5-di(t-butylperoxy)hexane, alpha-cumyl peroxy neodecanate, 1,1 -dimethyl-3-hydroxybutyl peroxy- 2-ethyl hexanoate, 2,5-dihydroperoxy-2,5-dimethylhexane, cumene hydroperoxide, t-butyl hydroperoxide, 2,2-di(t-butylperoxy)butane, ethyl 3,3-di(t-butylperoxy)-butylate, di(n-propyl)peroxy-dicarbonate, di(sec-butyl)perxy dicarbonate, di(2-ethylhexyl)peroxy dicarbonate, and azobis isobutyronitrile, and mixtures thereof Preferred are lauroyl peroxide and benzoyl peroxide.

The amount of initiator is preferably 0.3 to 5 parts by weight based on 100 parts by weight of poly(ester)(metha)acrylate. If the amount of initiator is less than 0.3 parts by weight, it is difficult to polymerize, and if it is more than 5 parts by weight, too large a polymer is formed, which has deteriorated mechanical properties.

The poly(ester)(metha)acrylate preferably has a weight-average molecular weight of 300 to 100,000.

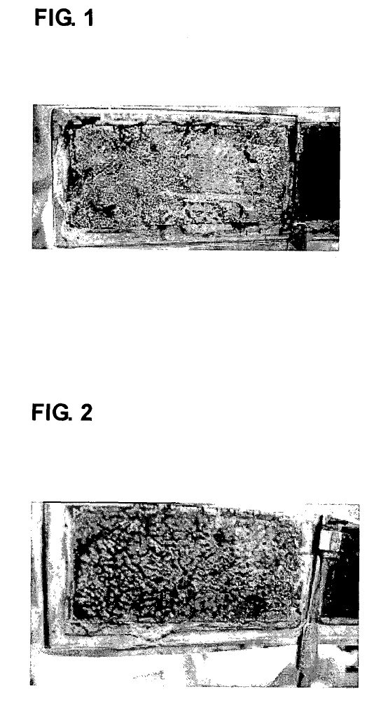

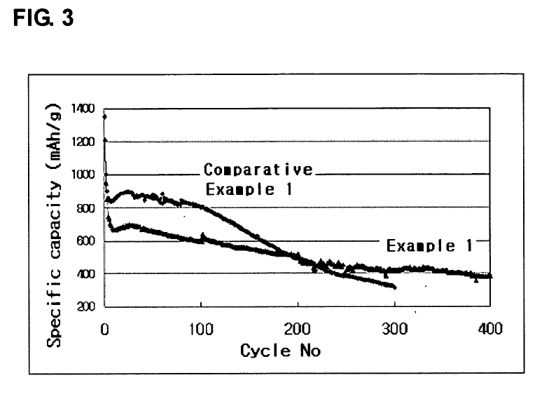

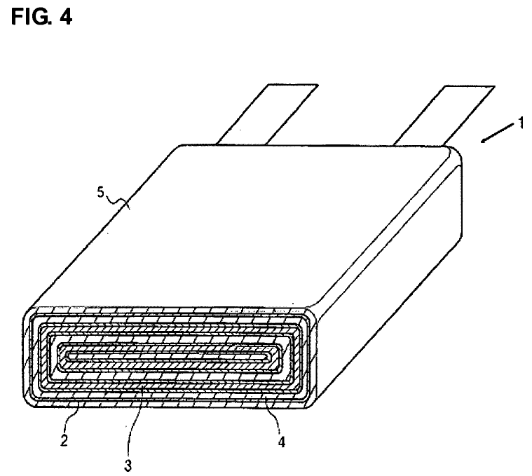

A lithium-sulfur battery according to one embodiment of the present invention is shown in FIG. 1. The battery includes a can 1 containing a positive electrode 3, a negative electrode 4, and a polymer electrolyte 2 according to the present invention between the positive electrode 3 and the negative electrode 4.

A method of fabricating a lithium sulfur battery using the polymer electrolyte will be described in more detail.

A monomer with a methacrylate group, an initiator, and an electrolyte are mixed to prepare a composition for preparing a polymer electrolyte.

Using the composition, a film-type polymer electrolyte is prepared. Alternatively, the composition is injected into a battery case and is polymerized in the battery. The film-type polymer electrolyte preferably has a thickness of 5 to 90 μm to provide good ionic conductivity.

The film-type polymer electrolyte is prepared by coating the composition on a substrate and polymerizing it by heat-treating or with UV radiation followed by separation of the resulting material from the substrate. The heat-treatment temperature depends on the half life of an initiator of the radical reaction, and it is suitably 40° C. to 110° C., and preferably 60° C. to 85° C. If the heat-treatment is performed at too low a temperature, the amount of the remaining unreacted monomer increases or the reaction time is long, causing an increase in cost. If the heat-treatment is performed at too high a temperature, excess lithium salt is decomposed.

The film-type polymer electrolyte additionally acts as a separator, and thus an additional separator is not required.

For polymerization in the battery, an electrode element is inserted into a battery case and the composition for preparing a polymer is injected into the case to fabricate a battery. The electrode element includes a positive electrode, a negative electrode, and a separator interposed between the positive electrode and the negative electrode. The battery is allowed to stand at 70° C. to 80° C. for 2 to 6 hours. During this time, polymerization occurs to form a polymer electrolyte. The separator may be a polyethylene separator, a polypropylene separator, a polyethylene/polypropylene two-layer separator, a polyethylene/polypropylene/polyethylene three-layer separator, a polypropylene/polyethylene/polypropylene three-layer separator, or other suitable type of separator.

The positive active material includes elemental sulfur (S₈), a sulfur-based compound, or a mixture thereof. The sulfur-based compound may be selected from Li₂Sₙ (n≧1), an organic-sulfur compound, or a carbon-sulfur polymer ((C₂Sₓ)ₙ:x=2.5 to 50, n≧2). The negative active material includes lithium metal or a lithium alloy of lithium/aluminum.

The following examples illustrate the present invention in further detail, but it is understood that the present invention is not limited by these examples.

Synthesis of Electrolyte

### COMPARATIVE EXAMPLES 1 TO 8

Poly(ethylene glycol) dimethacrylate (PEGDMA) with an average molecular weight of 330 was added to a IM solution of LiN(SO₂CF₃)₂ in dimethoxyethane/1,3-dioxolane (80/20 volume ratio) and shaken for 10 minutes. A trace of azobisisobutyronitrile (AIBN) was added to the resulting material and it was heated at 75° C. for 4 hours to gel. The physical properties of the obtained electrolyte are presented in the following Table 1.

TABLE 1

| | Component amount (g) | | | |
|---|---|---|---|---|
| | Electrolyte | PEGDMA | AIBN | Physical properties |
| Comparative | 30 | 1 | 0.01 | No gelation and increase in viscosity |
| Example 1 | | | | |
| Comparative | 25 | 1 | 0.01 | No gelation and increase in viscosity |
| Example 2 | | | | |
| Comparative | 20 | 1 | 0.01 | No gelation and increase in viscosity |
| Example 3 | | | | |
| Comparative | 15 | 1 | 0.01 | No gelation and increase in viscosity |
| Example 4 | | | | |
| Comparative | 12.5 | 1 | 0.01 | Gelation |
| Example 5 | | | | |
| Comparative | 10 | 1 | 0.01 | Gelation |
| Example 6 | | | | |
| Comparative | 7.5 | 1 | 0.01 | Gelation |
| Example 7 | | | | |
| Comparative | 5 | 1 | 0.01 | Gelation |
| Example 8 | | | | |

As shown in Table 1, when the electrolyte is used in the amount equal to 1250% or less of the monomer, gelation occurs, but when the electrolyte is used in an amount equal to 1500% or more of the monomer, gelation does not occur.

The product according to Comparative Example 6 was cast as a disk-type sample. The sample was attached to a stainless steel electrode, and ionic conductivity was measured at room temperature. The result was a good ionic conductivity of 2.0×10⁻³(S/cm).

### Examples 1 to 7

A tetrapropyltitanate catalyst was added to a mixture of 1M dipentaerythritol, 2M ε-caprolactone, and toluene. The amount of tetrapropyltitanate was 0.01 wt % of the dipentaerythritol. The resulting mixture was reacted at 50° C. to synthesize dipentaerythritol in which a hydroxide group at a terminal end was substituted with ε-caprolatone. Thereafter, 4M of acrylic acid and 2M of butylcarbonic acid were reacted with 1M of the monomer to prepare a polyester hexacrylate-based compound (PEHA) in which four hydroxide groups (—OH) at the terminal of the monomer were substituted with —OC(═O)(CH₂)₅OC(═O)CH₂═CH₂, and the remaining two hydroxide groups were substituted with —OC(═O)(CH₂)₃CH₃.

The polyester hexacrylate-based compound was added to a 1M solution of LiN(SO₂CF₃)₂ in dimethoxy ethane/1,3-dioxolane (80/20 volume ratio) and shaken for 10 minutes. A trace of AIBN was added to the resulting material and it was heated at 75° C. for 4 hours to gel. The physical properties of the obtained product are shown in Table 2.

TABLE 2

| | Component amount (g) | | | |
|---|---|---|---|---|
| | | Polyester hexacrylate- | | |
| | Electrolyte | based compound | AIBN | Physical properties |
| Example 1 | 60 | 1 | 0.01 | Gelation and occurrence of slight |
| | | | | leakage of the electrolyte |
| Example 2 | 50 | 1 | 0.01 | Gelation and occurrence of slight |
| | | | | leakage of the electrolyte |
| Example 3 | 40 | 1 | 0.01 | Gelation and occurrence of slight |
| | | | | leakage of the electrolyte |
| Example 4 | 30 | 1 | 0.01 | Gelation |
| Example 5 | 20 | 1 | 0.01 | Gelation |
| Example 6 | 10 | 1 | 0.01 | Gelation |
| Example 7 | 5 | 1 | 0.01 | Gelation |

As shown in Table 2, when the amount of the electrolyte is equal to 3000% or less of the monomer, the gelation suitably occurs so that leakage of the electrolyte from the polymer matrix does not occur and 4000% or more causes the electrolyte to leak from the polymer matrix even though gelation occurs.

The polymer matrices of Examples 1 to 4 were cast into disk-type samples. Each of the samples was attached on a stainless steel electrode, and the ionic conductivity was measured at room temperature. The results showed good ionic conductivities of 2.5×10⁻³ (S/cm) in Example 4 and 3.4×10⁻³ (S/cm) in Example 5.

### COMPARATIVE EXAMPLE 8

Use of Polyethylene Glycol Divinyl Ether (PEGDVE, Molecular Weight of 240)

The gelation tests were performed while the amount of the electrolytic solution was varied in amount equal to 500 to 3000% of the monomer, but no gelation occurred.

Fabrication of a Lithium Sulfur Cell

### COMPARATIVE EXAMPLE 9

67.5 wt % of elemental sulfur, 11.4 wt % of a SUPER-P conductive material, and 21.1 wt % of a polyethylene oxide binder were mixed in an acetonitrile solvent to prepare a positive active material slurry. The slurry was coated on a carbon-coated Al current collector. The coated current collector was pressed and dried at room temperature for 2 hours, followed by re-drying at 50° C. for at least 12 hours to produce a positive electrode.

Using the positive electrode and a lithium foil negative electrode, a lithium sulfur cell with a nominal capacity of 838 mAh/g was fabricated. A 1M LiN(SO₂CF₃)₂ in dimethoxyethane/1,3-dioxolane (80/20 volume ratio) electrolyte was used.

### COMPARATIVE EXAMPLES 10 TO 15

Lithium sulfur cells were fabricated by the same procedure as in Comparative Example 9, except that a composition for preparing a polymer electrolyte was used. The composition was prepared by adding PEGDMA and AIBN to the electrolytic solution in the amounts as shown in Table 3. The electrolytic solution was 1M LiN(SO₂CF₃)₂ in dimethoxyethane (80/20 volume ratio).

The cells according to Comparative Examples 9 to 15 were charged and discharged under the following conditions, and capacity at various c-rate (characteristics) and cycle life characteristic were measured. The results are shown in Table 3. In Table 3, capacity retention is expressed as a percentage value referring to a capacity for the 20th cycle compared to a capacity for the first cycle in the cycle life test.

First: cycle: 0.1C discharge (cut-off: 1.5V)

Second cycle: 0.2C charge (cut-off: 120% of nominal capacity or 2.8V) 0.1C discharge (cut-off 1.5V)

Third cycle: 0.2C charge (cut-off: 120% of nominal capacity or 2.8V) 0.2C discharge (cut-off 1.5V)

Fourth cycle (1^{st} in cycle life): 0.2C charge (cut-off: 120% of nominal capacity or 2.8V) 0.5C discharge (cut-off 1.5V)

Fifth or more cycles: the same as fourth cycle

TABLE 3

| | | | | Capacity at various C-rate | | | | | Capacity | |
|---|---|---|---|---|---|---|---|---|---|---|
| | | | | (mAh/g) | | | | Capacity at | at 0.5 C for | |
| | | | | First | | | | 0.5 C for | 20^{th} cycle | |
| | | | | cycle | | | | first cycle in | in the | Capacity |
| | Component ratio | | | at | | | | the cycle life | cycle life | retention |
| | Electrolyte | PEGDMA | AIBN | 0.1 C | 0.1 C | 0.2 C | 0.5 C | (mAh/g) | (mAh/g) | (%) |
| Comparative | 10 | 0 | 0 | 1522 | 797 | 793 | 804 | 804 | 877 | 109 |
| Example 9 | | | | | | | | | | |
| Comparative | 25 | 1 | 0.01 | 1058 | 843 | 709 | 562 | 562 | 473 | 84 |
| Example 10 | | | | | | | | | | |
| Comparative | 20 | 1 | 0.01 | 1097 | 835 | 670 | 517 | 517 | 453 | 88 |
| Example 11 | | | | | | | | | | |
| Comparative | 15 | 1 | 0.01 | 1099 | 839 | 647 | 500 | 500 | 403 | 81 |
| Example 12 | | | | | | | | | | |
| Comparative | 12 | 1 | 0.01 | 918 | 750 | 499 | 437 | 437 | 340 | 78 |
| Example 13 | | | | | | | | | | |
| Comparative | 10 | 1 | 0.01 | 1004 | 825 | 639 | 495 | 495 | 310 | 62 |
| Example 14 | | | | | | | | | | |
| Comparative | 8 | 1 | 0.01 | 827 | 820 | 610 | 462 | 462 | 278 | 60 |
| Example 15 | | | | | | | | | | |

As shown in Table 3, the cells according to Comparative Examples 10 to 15 with the composition exhibited inferior capacity and cycle life characteristics to that according to Comparative Example 9 with the electrolytic solution.

### COMPARATIVE EXAMPLES 16 TO 19

Lithium sulfur cells were fabricated by the same procedure as in Comparative Example 9, except that a composition for preparing a polymer electrolyte was used. The composition was prepared by adding PEGDMA and AIBN to an electrolytic solution as shown in Table 4. The electrolytic solution was 1M LiN(SO₂CF₃) in dimethoxyethane/1,3-dioxolane (80/20 volume ratio).

The cells according to Comparative Examples 9 to 12, 14, 16, and 19 were charged at 0.2C (cut-off: 120% of nominal capacity, or 2.8V) and discharged at 0.5C (cut-off 1.5V) 100 times. The lithium negative electrode was separated from the cell and exposed to the atmosphere to cause natural firing. The results are shown in Table 4.

TABLE 4

| | Component ratio | | | | |
|---|---|---|---|---|---|
| | Electrolyte | PEGDMA | AIBN | Final condition | Firing result |
| Comparative | 30 | 1 | 0.01 | No gelation and increases in viscosity | Two cells firing |
| Example 16 | | | | | |
| Comparative | 25 | 1 | 0.01 | No gelation and increases in viscosity | One cell firing |
| Example 10 | | | | | |
| Comparative | 20 | 1 | 0.01 | No gelation and increases in viscosity | No fire |
| Example 11 | | | | | |
| Comparative | 15 | 1 | 0.01 | No gelation and increases in viscosity | No fire |
| Example 12 | | | | | |
| Comparative | 12.5 | 1 | 0.01 | Gelation | No fire |
| Example 18 | | | | | |
| Comparative | 10 | 1 | 0.01 | Gelation | No fire |
| Example 14 | | | | | |
| Comparative | 7.5 | 1 | 0.01 | Gelation | No fire |
| Example 18 | | | | | |
| Comparative | 5 | 1 | 0.01 | Gelation | No fire |
| Example 19 | | | | | |
| Comparative | 10 | 0 | 0 | Electrolytic solution | Five cells firing |
| Example 9 | | | | | |

The cells according to Comparative Examples 10 to 12, 14, 16, and 19 exhibited no firing, as opposed to that according to Comparative Example 9. This result is considered to come about because a polymer layer is formed on the lithium negative electrode, which prevents contact between a surface of lithium and moisture.

### Examples 8 and 9

A lithium sulfur cell was fabricated by the same procedure as in Comparative Example 10 except that PEHA obtained from Example 1 was used and the amount thereof was changed as shown in Table 5.

The charge and discharge of the cells according to Examples 8 and 9 were performed under the same conditions as above. The results are shown in Table 5. For comparison, the result of Comparative Example 9 is also presented in Table 5.

TABLE 5

| | | | | Capacity at various C-rate | | | | Capacity | | | | |
|---|---|---|---|---|---|---|---|---|---|---|---|---|
| | | | | (mAh/g) | | | | at 0.5 C | Capacity | | Capacity | |
| | | | | First | | | | for first | at 0.5 C | Capacity | at 0.5 C | Capacity |
| | Component ratio | | | cycle | | | | cycle | for 300th | retention | for 400th | retention |
| | Electrolyte | PEHA | AIBN | (0.1 C) | 0.1 C | 0.2 C | 0.5 C | (mAh/g) | (mAh/g) | (1) (%) | (mAh/g) | (2) (%) |
| Example 8 | 60 | 1 | 0.01 | 1347 | 796 | 762 | 708 | 708 | 398 | 56 | 358 | 51 |
| Example 9 | 30 | 1 | 0.01 | 1264 | 724 | 651 | 563 | 563 | — | — | — | — |
| Comparative | 10 | 0 | 0 | 1522 | 797 | 793 | 804 | 804 | 313 | 39 | — | — |
| Example 9 | | | | | | | | | | | | |

(1) capacity retention is a percentage value determined by comparison between the capacity for the 300th cycle and the capacity for the 1st cycle in each of the cycle life tests
(2) capacity retention is a percentage value determined by comparison between the capacity for the 400^{th} cycle and the capacity for the 1st cycle in each of the cycle life tests

As shown in Table 5, the cell according to Example 8 exhibited higher capacity retention and better cycle life characteristics than the cell of Comparative Example 9. The cell according to Example 8 with the larger amount of electrolyte exhibited higher capacity retention than that according to Example 9.

The cell according to Example 8 had a capacity corresponding to the cell of Comparative Example 9 at 0.1C and 0.2C, and a lower capacity than the cell of Comparative Example 9 at 0.5C. However, the cell according to Example 8 had good cycle life characteristics and capacity retention for 300th cycle of 56%, compared to a capacity retention for the cell of Comparative Example 9 of 39%. In particular, the cell according to Example 8 had a reduced capacity loss as the cycles were repeated and a 51% capacity retention for the 400th cycle, that is, a 5% capacity loss over the 100th cycle between the 300th and 400th cycles. These results are believed to come about because a corrosion of the lithium negative electrode is restrained, as determined by separating the negative electrode from a cell that was repeatedly charged and discharged.

The negative electrodes separated from the cells of Example 8 and Comparative Example 9 after completion of the cycle life test are shown in FIGS. 1 and 2, respectively. The negative electrode according to Example 8 was not substantially damaged and was clear (FIG. 1) after 400th cycle, whereas the negative electrode according to Comparative Example 9 was damaged with the formation of dendrites after 300th cycle.

### Examples 3 to 6 and Reference Example 1

A lithium sulfur cell was fabricated by the same procedure as in Comparative Example 9, except that PEHA was used and the amount thereof was varied as shown in Table 6.

TABLE 6

| | Component ratio | | | | |
|---|---|---|---|---|---|
| | | Poly(ester) | | | Firing test |
| | Electrolyte | (metha)acrylate | AIBN | Final condition | result |
| Example 8 | 60 | 1 | 0.01 | Gelation but slight leakage | 1 cell firing |
| Example 10 | 50 | 1 | 0.01 | Gelation but slight leakage | No firing |
| Example 11 | 40 | 1 | 0.01 | Gelation but slight leakage | No firing |
| Example 12 | 30 | 1 | 0.01 | Gelation | No firing |
| Example 13 | 20 | 1 | 0.01 | Gelation | No firing |
| Example 9 | 10 | 1 | 0.01 | Gelation | No firing |
| Reference | 5 | 1 | 0.01 | Gelation | No firing |
| Example 1 | | | | | |
| Comparative | 10 | 0 | 0 | Electrolytic solution | 5 cells firing |
| Example 9 | | | | | |

The cells according to Examples 8 to 13 had no natural firing, as opposed to Comparative Example 9. These results are believed to have occurred because a polymer film formed on the negative electrode prevented contact between the lithium and moisture.

The cycle life characteristics of the cells according to Example 8 and Comparative Example 9 are presented in Table 7 and FIG. 2. The charge was performed a at 0.2C charge (cut-off: 120% of nominal capacity, or 2.8V) and at 0.5C discharge (cut-off 1.5V) for 300th cycle or more.

TABLE 7

| | | | | | | | Capacity | | |
|---|---|---|---|---|---|---|---|---|---|
| | | | | | | | retention | | |
| | Component ratio | | | | Capacity | Capacity | per | | |
| | | Poly(ester) | | Nominal | for first | for 300th | nominal | Capacity for | Capacity |
| | | (metha) | | capacity | cycle | cycle | capacity | 400th cycle | retention |
| | Electrolyte | acrylate | AIBN | (mAh/g) | (mAh/g) | (mAh/g) | (%) | (mAh/g) | (%) |
| Example 8 | 60 | 1 | 0.01 | 838 | 1215 | 425 | 50.7 | 383.0 | 45.7 |
| Comparative | 10 | 0 | 0 | 838 | 1351 | 313 | 37.4 | | |
| Example 9 | | | | | | | | | |

The cell according to Example 8 had a slightly lower capacity and a better cycle life characteristic than that of Comparative Example 9.

These results are believed to have occurred because the fluidity of the electrolytic solution decreased to make movement of a polysulfide active material from the positive electrode to the negative electrode and the corrosion of lithium difficult. This is shown from the negative electrode after the repeated charge and discharge.

The polymer electrolyte of the present invention exhibits good cycle life characteristics.

While the present invention has been described in detail with reference to the preferred embodiments, those skilled in the art will appreciate that various modifications and substitutions can be made thereto without departing from the spirit and scope of the present invention, as set forth in the appended claims.

What is claimed is:

1. A polymer electrolyte for a lithium sulfur battery comprising:
a monomer including a methacrylate group;
an initiator; and
an electrolytic solution comprising an organic solvent and a lithium salt.

2. The polymer electrolyte of claim 1, wherein the monomer has at least one carbon-carbon double bond at a terminal end.

3. The polymer electrolyte of claim 2, wherein the monomer is selected from the group consisting of multifunctional acrylates, poly(ethyleneglycol) dimethacrylate, poly(ethyleneglycol) diacrylate, poly(ethyleneglycol) divinylether ethylene glycol dimethacrylate, ethylene glycol diacrylate, ethyleneglycol divinylether, hexanediol diacrylate, tripropyleneglycol diacrylate, tetraethyleneglycol monoacrylate, caprolactone acrylate and mixtures thereof, wherein the multifunctional acrylate is poly(ester)(metha)acrylate in which hydroxide groups in (polyester)polyol are partially or totally substituted with (metha)acrylic ester and un-substituted hydroxide groups are substituted with a group having no radical reactivity.

4. The polymer electrolyte of claim 3, wherein the monomer is polyethyleneglycoldimethacrylate or poly(ester)(metha)acrylate in which hydroxide groups in (polyester)polyol are partially or totally substituted with (metha)acrylic ester and un-substituted hydroxide groups are substituted with a group having no radical reactivity.

5. The polymer electrolyte of claim 3, wherein the group having no radical reactivity is selected from the group consisting of C₁ to C₂₀ aliphatic hydrocarbon groups, C₅ to C₂₀ aromatic hydrocarbon groups, C₁ to C₂₀ ether groups, and C₁ to C₂₀ ester groups.

6. The polymer electrolyte of claim 3, wherein the mixing mole ratio of the methacrylic ester and the group having no radical reactivity is 1:0.01 to 1:100.

7. The polymer electrolyte of claim 3, wherein the monomer is poly(ester)(metha)acrylate in which hydroxide groups in (polyester)polyol are partially or totally substituted with (metha)acrylic ester and un-substituted hydroxide groups are substituted with a group having no radical reactivity.

8. The polymer electrolyte of claim 1, wherein the mixing weight ratio of the electrolytic solution to the monomer ranges from greater than 10:1 to 200:1.

9. The polymer electrolyte of claim 8, wherein the mixing weight ratio of the electrolytic solution to the monomer is 40 to 150:1.

10. The polymer electrolyte of claim 9, wherein the mixing weight ratio of the electrolytic solution to the monomer is 60 to 120:1.

11. The polymer electrolyte of claim 3, wherein the group having no radical reactivity is selected from the group consisting of —OC(═O)(CH₂)₃CH₃, —OC(═O)Ar where Ar is an unsubstituted or substituted aromatic hydrocarbon group, —OC(═O)(CH₂)ₙO(CH₂)ₙCH₃ where n is an integer from 1 to 20, —O(C═O)(CH₂)ₙOC(═O)(CH₂)ₙCH₃ where n is an integer from 1 to 20, and —O(C═O)CH═CH₂.

12. The polymer electrolyte of claim 1, wherein the monomer is a (metha)acrylic ester selected from —OC(═O)(CH₂)ₙOC(═O)CH═CH₂ and —OC(═O)(CH₂)ₙOC(═O)C(CH3)═CH₂, wherein n is an integer of 1 to 20.

13. The polymer electrolyte of claim 1, wherein the monomer is selected from compounds represented by the formulas 1 and 2: 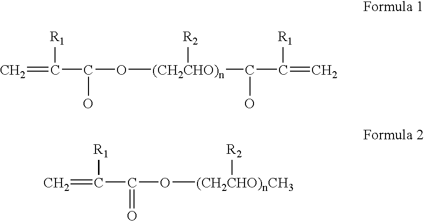
where R₁ is H or a C₁ to C₆ alkyl group; n is an integer from 1 to 100,000; and R₂ is H or a C₁ to C₆ alkyl group.

14. The polymer electrolyte of claim 1, wherein the initiator is at least one selected from the group consisting of isobutyl peroxide, lauroyl peroxide, benzoyl peroxide, m-tolluoyl peroxide, t-butyl peroxy-2-ethyl hexanoate, t-butyl peroxy bibarate, t-butyloxyneodecanate, diisopropyl peroxy dicarbonate, diethoxy peroxy dicarbonate, bis-(4-t-butylcyclohexyl)peroxy dicarbonate, dimethoxy isopropyl peroxy dicarbonate, dicyclo hexylperoxy dicarbonate, 3,3,5-trimethylhexanoyl peroxide, succinic peroxide didecarbonylperoxide, dicumyl peroxide, di-t-butyl peroxide, 2,5-dimethyl-2,5-di(t-butylperoxy)hexane, alpha-cumyl peroxy neodecanate, 1,1-dimethyl-3-hydroxybutyl peroxy-2-ethyl hexanoate, 2,5-dihydroperoxy-2,5-dimethylhexane, cumene hydroperoxide, t-butyl hydroperoxide, 2,2-di(t-butylperoxy)butane, ethyl 3,3-di(t-butylperoxy)-butylate, di(n-propyl)peroxy-dicarbonate, di(sec-butyl)perxy dicarbonate, di(2-ethylhexyl)peroxy dicarbonate, and azobis isobutyronitrile.

15. The polymer electrolyte of claim 1, wherein the initiator is present in an amount of 0.3 to 5 parts by weight based on 100 parts by weight of the polymer.

16. The polymer electrolyte of claim 1, wherein the polyester polyol is at least one selected from the group consisting of trialkylols, glycerols, and erythritols.

17. A lithium sulfur battery comprising:
a positive electrode comprising at least one positive active material selected from the group consisting of elemental sulfur, sulfur-based compounds, and mixtures thereof,
a negative electrode comprising a negative active material selected from the group consisting of materials that are capable of reversibly intercalating or deintercalating lithium ions, materials that react with lithium ions to prepare a lithium-included compound, lithium metals, and lithium alloys; and
a polymer electrolyte comprising a monomer including a methacrylate group, an initiator, and an electrolytic solution comprising an organic solvent and a lithium salt.

18. The polymer electrolyte of claim 17, wherein the monomer has at least one carbon-carbon double bond at a terminal end.

19. The lithium sulfur battery of claim 18, wherein the monomer is selected from the group consisting of multifunctional acrylates, poly(ethyleneglycol) dimethacrylate, poly(ethyleneglycol) diacrylate, poly(ethyleneglycol) divinylether ethylene glycol dimethacrylate, ethylene glycol diacrylate, ethyleneglycol divinylether, hexanediol diacrylate, tripropyleneglycol diacrylate, tetraethyleneglycol monoacrylate, caprolactone acrylate and mixtures thereof, wherein the multifunctional acrylate is poly(ester)(metha)acrylate in which hydroxide groups in (polyester)polyol are partially or totally substituted with (metha)acrylic ester and un-substituted hydroxide groups are substituted with a group having no radical reactivity.

20. The lithium sulfur battery of claim 19, wherein the monomer is polyethyleneglycoldimethacrylate or poly(ester)(metha)acrylate in which hydroxide groups in (polyester)polyol are partially or totally substituted with (metha)acrylic ester, and un-substituted hydroxide groups are substituted with a group having no radical reactivity.

21. The lithium sulfur battery of claim 20, wherein the monomer is poly(ester)(metha)acrylate in which hydroxide groups in (polyester)polyol are partially or totally substituted with (metha)acrylic ester, and un-substituted hydroxide groups are substituted with a group having no radical reactivity.

22. The lithium sulfur battery of claim 19, wherein the group having no radical reactivity is selected from the group consisting of C₁ to C₂₀ aliphatic hydrocarbon groups, C₅ to C₂₀ aromatic hydrocarbon groups, C₁ to C₂₀ ether groups and C₁ to C₂₀ ester groups.

23. The lithium sulfur battery of claim 19, wherein the group having no radical reactivity is selected from the group consisting of —OC(═O)(CH₂)₃CH₃, —OC(═O)Ar where Ar is an unsubstituted or substituted aromatic hydrocarbon group, —OC(═O)(CH₂)ₙO(CH₂)ₙCH₃ where n is an integer of 1 to 20, —O(C═O)(CH₂)ₙOC(═O)(CH₂)ₙCH₃ where n is an integer of 1 to 20, and —O(C═O)CH═CH₂.

24. The lithium sulfur battery of claim 17, wherein the mixing weight ratio of the electrolytic solution to the monomer ranges from greater than 10:1 to 200:1.

25. The lithium sulfur battery of claim 24, wherein the mixing weight ratio of the electrolytic solution to the monomer is 40 to 150:1.

26. The lithium sulfur battery of claim 25, wherein the mixing weight ratio of the electrolytic solution to the monomer is 60 to 120:1.

27. The lithium sulfur battery of claim 17, wherein the monomer is a (metha)acrylic ester selected from —OC(═O)(CH₂)ₙOC(═O)CH═CH₂ and —OC(═O)(CH₂)ₙOC(═O)C(CH₃)═CH₂, where n is an integer of 1 to 20.

28. The lithium sulfur battery of claim 17, wherein the monomer is selected from the group consisting of polymers of polyester (metha)acrylate in which hydroxide groups in polyester polyol are partially or totally substituted with (metha)acrylic ester, poly(ethyleneglycol)dimethacrylate, poly(ethyleneglycol) diacrylate, poly(ethyleneglycol) divinylether ethylene glycol dimethacrylate, ethylene glycol diacrylate, ethyleneglycol divinylether, hexanediol diacrylate, tripropyleneglycol diacrylate, tetraethyleneglycol monoacrylate, caprolactone acrylate, and mixtures thereof.

29. The lithium sulfur battery of claim 17, wherein the monomer is selected from compounds represented by the formulas 1 and 2: 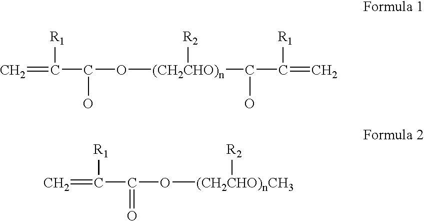
where R₁ is H or a C₁ to C₆ alkyl group; n is an integer of 1 to 100,000; and R₂ is H or a C₁ to C₆ alkyl group.

30. The lithium sulfur battery of claim 19, wherein the mixing mole ratio of the methacrylic ester and the group having no radical reactivity is 1:0.01 to 1:100.

31. The lithium sulfur battery of claim 17, wherein the initiator is at least one selected from the group consisting of isobutyl peroxide, lauroyl peroxide, benzoyl peroxide, m-tolluoyl peroxide, t-butyl peroxy-2-ethyl hexanoate, t-butyl peroxy bibarate, t-butyloxyneodecanate, diisopropyl peroxy dicarbonate, diethoxy peroxy dicarbonate, bis-(4-t-butylcyclohexyl)peroxy dicarbonate, dimethoxy isopropyl peroxy dicarbonate, dicyclo hexylperoxy dicarbonate, 3,3,5-trimethylhexanoyl peroxide, succinic peroxide didecarbonylperoxide, dicumyl peroxide, di-t-butyl peroxide, 2,5-dimethyl-2,5-di(t-butylperoxy)hexane, alpha-cumyl peroxy neodecanate, 1,1-dimethyl-3-hydroxybutyl peroxy-2-ethyl hexanoate, 2,5-dihydroperoxy-2,5-dimethylhexane, cumene hydroperoxide, t-butyl hydroperoxide, 2,2-di(t-butylperoxy)butane, ethyl 3,3-di(t-butylperoxy)-butylate, di(n-propyl)peroxy-dicarbonate, di(sec-butyl)perxy dicarbonate, di(2-ethylhexyl)peroxy dicarbonate, and azobis isobutyronitrile.

32. The lithium sulfur battery of claim 17, wherein the initiator is present in an amount of 0.3 to 5 parts by weight based on 100 parts by weight of the polymer.

33. The lithium sulfur battery of claim 17, wherein the polyester polyol is at least one selected from the group consisting of trialkylols, glycerols, and erythritols.

34. The lithium sulfur battery of claim 17, wherein the positive active material is selected from the group consisting of elemental sulfur, organic sulfur compounds selected from the group consisting of Li₂Sₙ, where n≧1, and Li₂Sₙ, where n≧1, dissolved in catholyte, and a carbon-sulfur polymer of the formula (C₂Sₓ)ₙ, where x=2.5 to 50 and n≧2.
